(19) United States
(12) Patent Application Publication
(10) Pub. No.: US 2013/0031146 A1
(43) Pub. Date: Jan. 31, 2013

(54) INTEGRATED MANAGEMENT APPARATUS, DOCUMENT MANAGEMENT METHOD, AND STORAGE MEDIUM

(71) Applicant: Kazuya Nakashima, Kawasaki-shi (JP)

(72) Inventor: Kazuya Nakashima, Kawasaki-shi (JP)

(73) Assignee: CANON KABUSHIKI KAISHA, Tokyo (JP)

(21) Appl. No.: 13/557,907

(22) Filed: Jul. 25, 2012

(30) Foreign Application Priority Data
Jul. 28, 2011 (JP) 2011-165115

(51) Int. Cl. G06F 17/30

(52) U.S. Cl. 707/822; 707/E17.01; 707/E17.008

(57) ABSTRACT

An integrated management system registers a library associated with a reference destination of a shortcut file. The integrated management system determines whether a folder on the reference destination of a selected shortcut file can be referred to via the library. When the folder on the reference destination of the selected shortcut file can be referred to via the library, the integrated management system displays information indicating the folder.

### BACKGROUND OF THE INVENTION

1. Field of the Invention

The present invention relates to an integrated management apparatus, a document management method, and a storage medium.

2. Description of the Related Art

A document management system has been discussed which has various functions for storing an electronic document to a folder as a predetermined data storage region and operating the stored document. When a plurality of different document management systems access folders managed by the respective systems, a user needs to start the plurality of the document management systems. Therefore, there are issues of troublesomeness for the user to operate different interfaces and difficulty of cooperation between the document management systems. In order to solve the issues, an integrated management apparatus is discussed which can integrally manage folders managed by a plurality of document management systems.

A reference destination of the folder managed by different document management systems is registered to the integrated management apparatus, thus the integrated management apparatus can integrally manage data storage regions of various document management systems without starting the plurality of the document management systems.

Japanese Patent Application Laid-Open No. 2002-091813 discusses an integrated management system that can integrally manage documents in respective document management databases in a plurality of computers connected to a network and create a shortcut of the document in the database.

However, with the conventional integrated management apparatus, when execution of a shortcut file indicating the reference destination of the file or the folder is instructed, and if the reference destination of the shortcut is the folder managed by the individual document management system, the relevant document management system is started. In other words, a user needs to execute an operation on the reference destination with an interface corresponding to the individual document management system. Therefore, it is not possible to solve the issues, which is solved by the integrated management apparatus, of the troublesomeness for operating different interfaces and the difficulty for cooperation between the document management systems.

### SUMMARY OF THE INVENTION

The present invention is directed to an integrated management apparatus that can display a reference destination of a shortcut file to be viewed even if an individual document management system manages the reference destination when the reference destination indicates a folder that can be viewed by the integrated management apparatus.

According to an aspect of the present invention, an integrated management apparatus that manages a folder managed by a plurality of document management systems includes a registration unit configured to register a library associated with a reference destination of a shortcut file, a first determination unit configured to determine whether a selected file is the shortcut file, a second determination unit configured to determine whether the reference destination of the shortcut file is a folder if it is determined that the selected file is the shortcut file, a third determination unit configured to determine whether the folder can be referred to via the library if it is determined that the reference destination of the shortcut file is the folder, and a first display unit configured to display information indicating the folder without starting the document management system that manages the folder if it is determined that the folder can be referred to via the library.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration according to an exemplary embodiment of the present invention.

FIG. 2 illustrates an example of a hardware configuration of a data processing apparatus.

FIG. 3 illustrates an example of functional blocks of the data processing apparatus.

FIGS. 4A and 4B illustrate examples of a management user interface (UI) and library information.

FIG. 5 illustrates an example of a shortcut file.

FIG. 6 illustrates a flowchart of an example of operational processing of an integrated management system.

FIG. 7 illustrates an example of a management UI.

FIG. 8 illustrates a flowchart of registration canceling processing of a temporary library.

FIG. 9 illustrates a flowchart of registration canceling processing of the temporary library.

### DESCRIPTION OF THE EMBODIMENTS

Various exemplary embodiments, features, and aspects of the invention will be described in detail below with reference to the drawings.

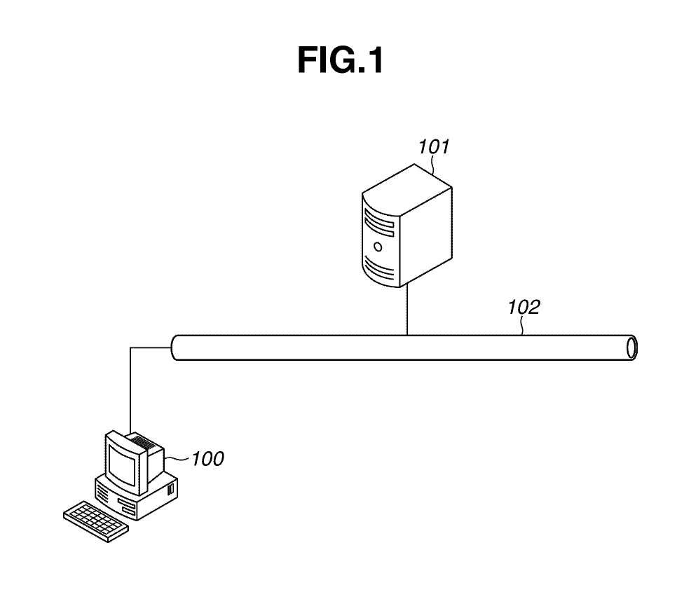

FIG. 1 illustrates an example of a system configuration according to an exemplary embodiment of the present invention. A system in FIG. 1 includes a data processing apparatus 100 and a file server 101. The data processing apparatus 100 is communicated with the file server 101 via a network 102 such as a local area network (LAN). The system may include a plurality of the data processing apparatuses 100 or the file servers 101.

The data processing apparatus 100 is an integrated management apparatus according to the present exemplary embodiment and integrally manages folders managed by a plurality of management systems. According to the present exemplary embodiment, the management system is a document management system functioning as application for managing a document file. The document management system is stored to a hard disk provided for the data processing apparatus 100. For example, a different document management system is provided for every extension of the document file. The file server 101 is a computer including a data storage region.

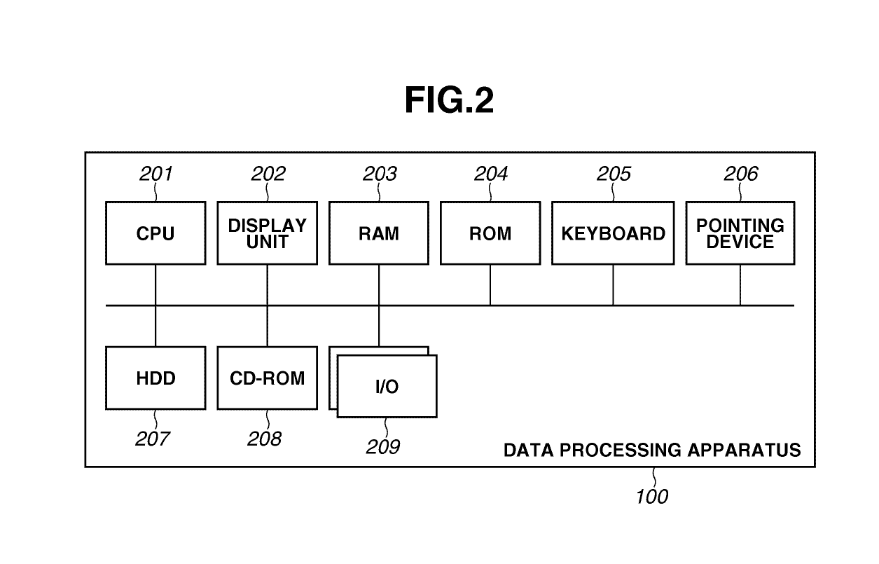

FIG. 2 illustrates an example of a hardware configuration of the data processing apparatus 100. The data processing apparatus 100 includes a central processing unit (CPU) 201, a display unit 202, a random access memory (RAM) 203, and a read only memory (ROM) 204. Further, the data processing apparatus 100 includes a keyboard 205, a pointing device 206, a hard disk drive (HDD) 207, a compact disk read only memory (CD-ROM) 208, and an input/output (I/O) 209.

The CPU 201 entirely controls the data processing apparatus 100. More specifically, the CPU 201 executes a control program stored in the ROM 204. The display unit 202 displays document contents. The RAM 203, the ROM 204, the HDD 207, and the CD-ROM 208 store information required to execute the program and various information pieces. The I/O 209 communicates data with an external apparatus. The keyboard 205 and the pointing device 206 are used to input information corresponding to an operation of a user. For example, the keyboard 205 and the pointing device 206 input values required for document edition.

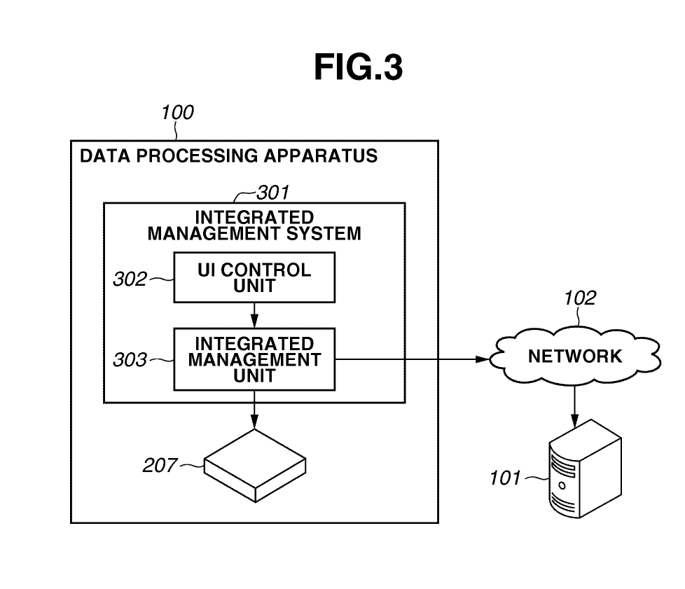

FIG. 3 illustrates an example of functional blocks of the data processing apparatus 100. The data processing apparatus 100 includes an integrated management system 301. The integrated management system 301 has a function for managing a document file. The individual document file is managed by the document management system in the data processing apparatus 100 or a document management system provided for an external apparatus connected to the data processing apparatus 100 via the network 102. The integrated management system 301 starts the document management system, thereby displaying the individual document file.

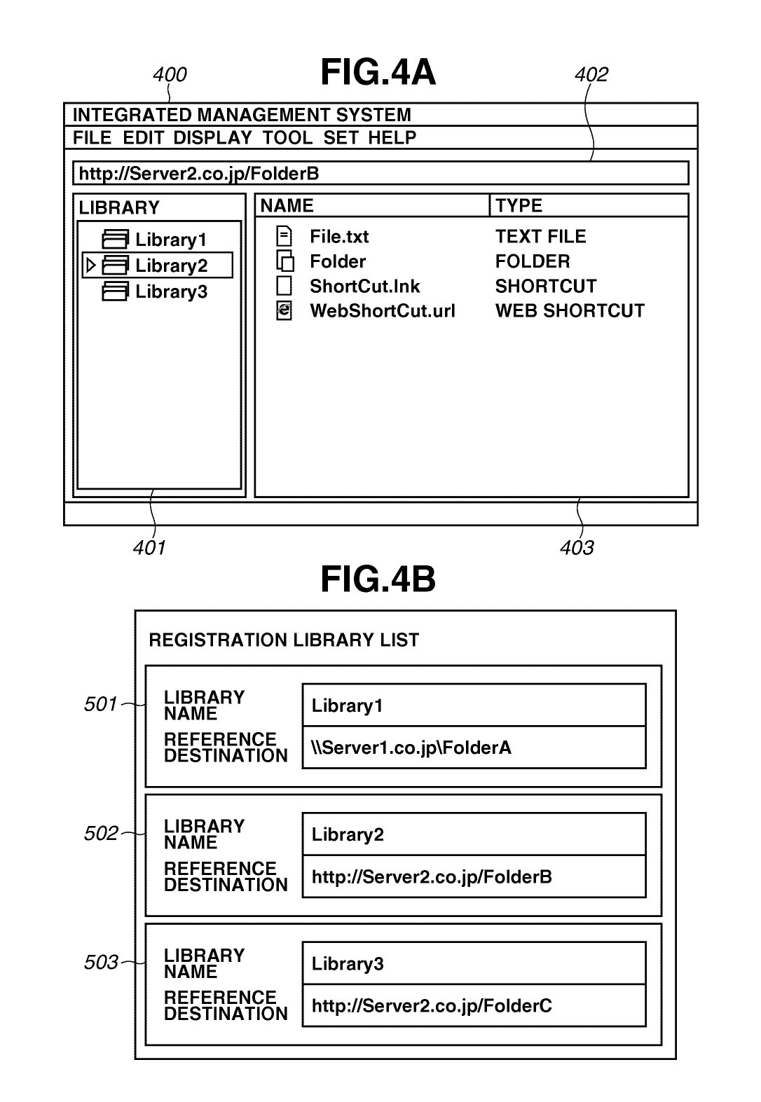

The integrated management system 301 in FIG. 3 includes a user interface (UI) control unit 302 and an integrated management unit 303. The UI control unit 302 controls an output to the display unit 202 in FIG. 2 and inputs from the keyboard 205 and the pointing device 206 with an operation of the user. The UI control unit 302 accesses the hard disk 207 or the file server 101 via the integrated management unit 303 for a file operation based on an input value. The file operation contains registration of information about the document file to the data storage region in the file server 101, and acquisition of information about the document file from the file server 101. The UI control unit 302 outputs display contents reflecting the file operation to the display unit 202. For example, the UI control unit 302 displays a management user interface (UI) and library information, which are described below with reference to FIGS. 4A and 4B, on the display unit 202.

The integrated management unit 303 controls the access to the data storage region of the file server 101 or the management thereof via the hard disk 207 or the network 102 from the integrated management system 301. For example, the integrated management unit 303 registers and manages a library including the folder of the document file in the file server 101. The folder is a data storage region. The library is managed to be referred to from the integrated management system 301. The integrated management unit 303 acquires information about the folder or the library from the file server 101. According to the present exemplary embodiment, a document management method and a computer program are realized by functions of the integrated management system 301 in FIG. 3.

FIGS. 4A and 4B illustrate examples of the management user interface (UI) 400 and the library information according to a first exemplary embodiment. FIG. 4A illustrates the management UI 400 displayed by the integrated management system 301. The management UI 400 is a window (operational screen) of the integrated management system 301. The management UI 400 displays a library registered in the file server 101 and information of the folder and the file included in the library.

The management UI 400 includes a library list UI 401, a reference destination display UI 402, and a file list UI 403. The library list UI 401 displays a list of registered libraries (a registration library list). The library is associated with a reference destination of the folder as an execution target by the user operation or the like. The integrated management system 301 can view and edit a document on the reference destination. More specifically, the integrated management system 301 registers the library and thus can refer to the reference destination associated with the library.

The reference destination display UI 402 displays the reference destination associated with the registered library. The file list UI 403 displays and operates a file list on the reference destination associated with the registered library.

FIG. 4B illustrates an example of the registration library list, which is a list of the registered libraries. The registration library list in FIG. 4B corresponds to the list of the registered libraries displayed on the library list UI 401 in FIG. 4A. The registered library includes corresponding information between a library name and the reference destination (folder) associated with the library.

In the example in FIG. 4B, the registration library list includes registered libraries 501 to 503. The registered library 501 includes corresponding information between a library name “Library1” and a reference destination “¥¥Server1.co.jp¥FolderA”.

The registered library 502 includes corresponding information between a library name “Library2” and a reference destination “http://Server2.co.jp/FolderB”. The registered library 503 includes corresponding information between a library name “Library3” and a reference destination “http://Server2.co.jp/FolderC”.

An example of managing the libraries by the integrated management system 301 is described below. The library list UI 401 in FIG. 4A displays three libraries. That is, the three libraries are registered as registered libraries.

When a user selects the library on the library list UI 401, the integrated management system 301 displays the library information corresponding to the selection operation on the reference destination display UI 402 and the file list UI 403.

The library list UI 401 in FIG. 4A indicates that “Library2” is selected. The reference destination display UI 402 displays “http://Server2.co.jp/FolderB” as the reference destination associated with the selected “Library2”.

The file list UI 403 displays a list of a file and a folder managed in the data storage region of the reference destination “http://Server2.co.jp/FolderB” associated with “Library2”.

When the user selects the folder displayed on the file list UI 403, the integrated management system 301 displays the data region in the folder on the file list UI 403.

For example, when the user double-clicks a folder “Folder” on the file list UI 403, the file list UI 403 executes the following processing. The file list UI 403 displays the list of the file and the folder managed in the data storage region of the reference destination “http://Server2.co.jp/FolderB/Folder”. In conjunction with the operation, the reference destination display UI 402 displays “http://Server2.co.jp/FolderB/Folder”. Further, the library list UI 401 displays “Folder” in a selectable state under the display of “Library2” with a tree structure.

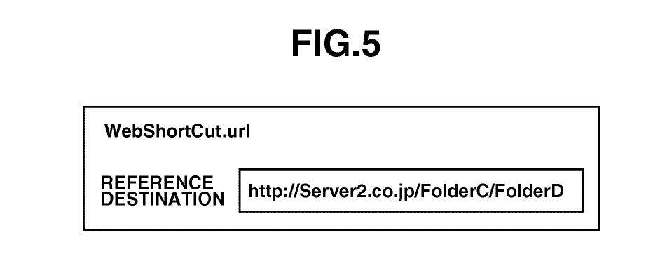

FIG. 5 illustrates an example of a shortcut file. The shortcut file includes the reference destination of the file and the folder. The shortcut file is a file having a mechanism for performing an operation similar to processing for opening the file or the folder on the reference destination when it is executed. The shortcut file may include not only a shortcut file of a general operation system (OS) or a web shortcut file, but also a shortcut file specific to another document management system.

A shortcut file “WebShortCut.url” in FIG. 5 is associated with a reference destination “http://Server2.co.jp/FolderC/FolderD”. When the shortcut file is selected, the integrated management unit 303 in the integrated management system 301 executes the corresponding shortcut file.

When the shortcut file is executed, a web page viewing system associated with an extension “url” is started. The web page viewing system is realized with a function of the UI control unit 302 provided for the integrated management system 301. Accordingly, the reference destination “http://Server2.co.jp/FolderC/FolderD” is displayed on the web page viewing system.

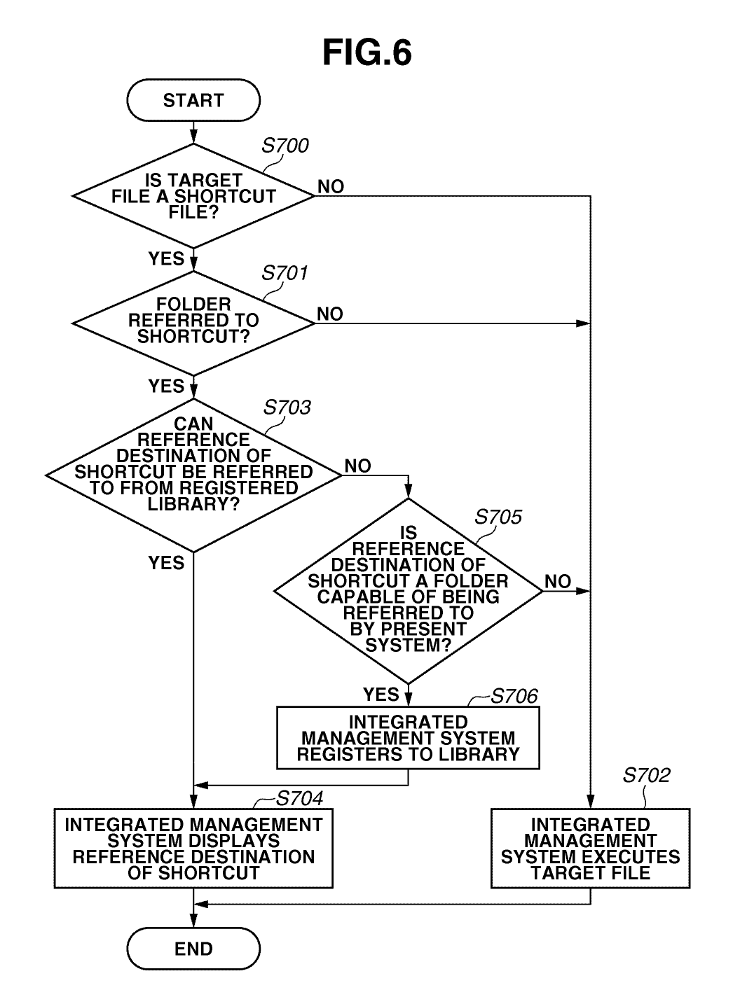

FIG. 6 illustrates a flowchart of an example of operational processing of the integrated management system 301. When the reference destination of the shortcut file can be viewed by the integrated management system 301, the integrated management system 301 displays the reference destination.

The user first selects the file from the file list UI 403 in FIG. 4A, and performs an operation for executing the file, such as double-click. In step S700, the integrated management unit 303 functions as a first determination unit, and determines whether a target file is the shortcut file. The integrated management unit 303 determines whether the target file is the shortcut file as follows. An extension list of the shortcut file is stored in advance to the integrated management system 301. If the stored extension list is similar to the extension of the file as the execution target, the integrated management unit 303 determines that the file as the execution target is the shortcut file.

If the integrated management unit 303 determines that the file as the execution target is not the shortcut file (NO in step S700), then in step S702, the integrated management unit 303 executes the target file. If the target file is a general file, the integrated management unit 303 opens the file from the execution file corresponding to the extension. If the target subjected to the double-click is the folder, the integrated management unit 303 displays the file list in the folder. If the integrated management unit 303 determines that the file as the execution target is the shortcut file (YES in step S700), the processing proceeds to step S701.

In step S701, the integrated management unit 303 functions as a second determination unit, and determines whether the reference destination of the shortcut file as the execution target is the folder. Processing in step S701 is specifically described. The integrated management unit 303 can change a method of the determination every extension of the shortcut file. The shortcut file of a general OS corresponds to a local file path or a network file path. Therefore, if the file as the execution target is the shortcut file of the general OS and there is no extension on the reference destination, the integrated management unit 303 determines that the reference destination is the folder.

The integrated management unit 303 may determine whether the reference destination of the file as the execution target is the folder using a known application programming interface (API) for determining whether the file path indicates the file or the folder.

The web shortcut file includes a uniform resource locator (URL) as the reference destination. Therefore, if the file as the execution target is a web shortcut file, the integrated management unit 303 determines that the reference destination is the folder when the reference destination ends with a slash mark.

In addition, the shortcut file specific to the document management system has a rule unique thereto. Therefore, if the file as the execution target is the shortcut file specific to the document management system, the integrated management unit 303 determines whether the reference destination is the folder using the API provided by the document management system. If the shortcut file of the document management system is under a rule based on a general shortcut file, a determination method similar to that of the general shortcut file is used.

If the integrated management unit 303 determines that the reference destination of the shortcut file as the execution target is not the folder (NO in step S701), the processing proceeds to step S702. In step S702, the integrated management unit 303 executes the shortcut file as the execution target. More specifically, the integrated management unit 303 executes the file on the reference destination given to the shortcut file.

If the integrated management unit 303 determines that the reference destination of the shortcut file as the execution target is the folder (YES in step S701), the processing proceeds to step S703. In step S703, the integrated management unit 303 functions as a third determination unit, and determines whether the reference destination of the shortcut file can be referred to by the registered library.

The determination processing in step S703 is described. If the reference destination of the shortcut file is under the folder indicated by the reference destination of the registered library, the integrated management unit 303 determines that the reference destination of the shortcut file can be referred to by the relevant library. More specifically, the integrated management unit 303 compares the reference destination of the shortcut file with the reference destination of the library. If a character string on the reference destination of the library prefix-matches that on the reference destination of the shortcut, the integrated management unit 303 determines that the reference destination of the shortcut file can be referred to by the library.

For example, it is assumed that a shortcut file “WebShortCut.url” in FIG. 5 is an execution target. The integrated management unit 303 first compares the reference destination of the shortcut file with the reference destination of the library included in the registration library list in FIG. 4B. The reference destination of the shortcut file does not prefix-match the reference destinations of the registered libraries 501 and 502. Therefore, the integrated management unit 303 determines that the reference destination of the shortcut file cannot be not referred to from Library1 and Library2.

On the other hand, the reference destination of the shortcut file prefix-matches the reference destination of the registered library 503. Therefore, the integrated management unit 303 determines that the reference destination of the shortcut file can be referred to by Library3. If there is at least one Library that can refer to the reference destination of the shortcut file, the integrated management unit 303 determines that the reference destination of the shortcut file can be referred to by the library (YES in step S703). If there are not any Libraries that can refer to the reference destination of the shortcut file, the integrated management unit 303 determines that the reference destination of the shortcut file cannot be referred to by the library (NO in step S703).

If the integrated management unit 303 determines that the reference destination of the shortcut file can be referred to by the registered library (YES in step S703), the processing proceeds to step S704. In step S704, the integrated management unit 303 displays the reference destination of the shortcut file. In other words, the integrated management unit 303 functions as a first display unit that displays information indicating the folder on the reference destination by the integrated management system 301 without starting the document management system for managing the folder on the reference destination of the shortcut.

For example, if the shortcut file is “WebShortCut.url” in FIG. 5, the integrated management unit 303 displays the reference destination of “WebShortCut.url” on the management UI 400 of the integrated management system 301. More specifically, the integrated management unit 303 displays “http://Server2.co.jp/FolderC/FolderD” on the reference destination display UI 402 in FIG. 4A. The integrated management unit 303 displays a file list on the reference destination on the file list UI 403.

If the integrated management unit 303 determines that the reference destination of the shortcut file cannot be referred to by the registered library (NO in step S703), the processing proceeds to step S705. In step S705, the integrated management unit 303 determines whether the reference destination of the shortcut is a folder that can be referred to from the integrated management system 301. More specifically, the integrated management unit 303 determines whether the reference destination is the folder that can be referred to from the integrated management system 301 based on the presence or absence of an access authority of the folder.

The integrated management unit 303 checks whether the integrated management system 301 has the access authority of the folder on the reference destination. If the integrated management system 301 has at least a viewing authority, the integrated management unit 303 determines that the reference destination is the folder that can be referred to from the integrated management system 301. If the integrated management unit 303 cannot check the applying state of the access authority, the integrated management unit 303 actually accesses the folder on the reference destination. If the integrated management unit 303 can acquire the list of files, the integrated management unit 303 may determine that the folder can be referred to from the integrated management system 301.

If the integrated management unit 303 determines that that the reference destination of the shortcut is the folder that cannot be referred to from the integrated management system 301 (NO in step S705), the processing shifts to step S702. The integrated management unit 303 executes the folder on the reference destination of the shortcut. More specifically, the integrated management unit 303 starts the document management system corresponding to the extension of the folder to display contents in the folder.

If the integrated management unit 303 determines that the reference destination of the shortcut is the folder that can be referred to from the integrated management system 301 (YES in step S705), the processing proceeds to step S706. In step S706, the integrated management unit 303 registers the library, and the processing progresses to step S704. In other words, the integrated management unit 303 functions as a registration unit that registers the library associated with the reference destination of the shortcut file. The library is registered by designating a library name and the reference destination and adding them to the list of the registered libraries. The registered library can be viewed from the integrated management system 301. Therefore, the reference destination of the shortcut file can be viewed from the integrated management system 301 via the library registered in step S706.

The integrated management system 301 provided for the data processing apparatus according to the first exemplary embodiment executes the following processing if the folder on the reference destination of the shortcut file is registered to the library to be referred to from the integrated management system 301. The integrated management system 301 displays the folder without starting the document management system which manages the folder on the reference destination. Therefore, a user can save time and effort for operating a plurality of the document management systems, and further the cooperation between the document management systems becomes easy.

A second exemplary embodiment of the present invention is described. The data processing apparatus manages the library (in step S706 in FIG. 6) to be registered in association with the reference destination of the shortcut by the integrated management system 301, as a temporary library, separately from the library registered by the user.

If the number of the libraries to be registered according to the first exemplary embodiment increases, this makes the user confused between the library registered by the user and another, and makes it difficult for the user to search for the library to use. The data processing apparatus according to the second exemplary embodiment determines whether there is the temporary library at the end of the integrated management system 301, and cancels the registration of the temporary library based on the determination result. In other words, the integrated management unit 303 functions as a registration canceling unit that determines whether there is the registered temporary library at the end of the operation of the integrated management system 301, and if it is determined that there is the temporary library, the integrated management unit 303 performs processing for canceling the registration of the temporary library.

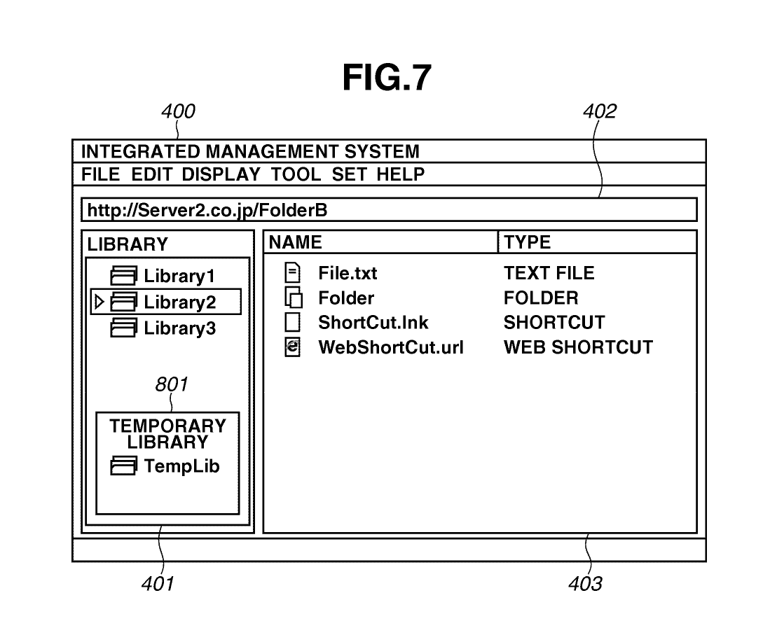

FIG. 7 illustrates an example of a management UI 400 displayed by the integrated management system 301 according to the second exemplary embodiment. The integrated management system 301 displays the library registered in step S706 in FIG. 6, as the temporary library, on a temporary library list UI 801. More specifically, the integrated management unit 303 functions as a second display unit that displays the registered temporary library. The temporary library list UI 801 has the similar function to that of the library list UI 401 in FIG. 4A.

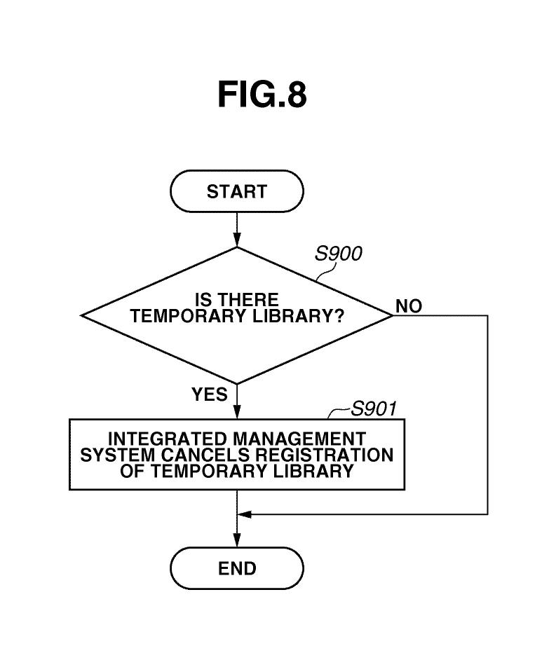

FIG. 8 illustrates a flowchart of the registration canceling processing of the temporary library. In step S900, the integrated management unit 303 determines whether there is the registered temporary library at the end of the operation of the integrated management system 301.

If the integrated management unit 303 determines that there is no registered temporary library (NO in step S900), the processing ends. If the integrated management unit 303 determines that there is the registered temporary library (YES in step S900), the processing proceeds to step S901. In step S901, the integrated management unit 303 cancels the registration of the temporary library.

There may be a case that a user wants to use the registered temporary library, i.e., the library displayed on the temporary library list UI 801, not temporarily but continuously. Therefore, the integrated management unit 303 may move the library displayed on the temporary library list UI 801 to the library list UI 401 in response to the user operation to enable the user to continuously use the temporary library.

The data processing apparatus according to the second exemplary embodiment can bring the following effects. In step S901, the integrated management unit 303 cancels the registration of the temporary library, and the temporary library is not displayed on the temporary library list UI 801 at the next start time of the integrated management system 301. Consequently, it is possible to prevent temporary libraries from unexpectedly increasing. Thus, the user can easily search for the library to use.

A third exemplary embodiment of the present invention is described. With a data processing apparatus according to the third exemplary embodiment, the integrated management system 301 manages the library to be registered in association with the reference destination of the shortcut as the temporary library, similarly to the data processing apparatus according to the second exemplary embodiment.

According to above-described the second exemplary embodiment, if there is the temporary library at the end of the operation of the integrated management system 301, the integrated management unit 303 cancels the registration of the temporary library. However, there is a case that the registration of the temporary library may not be canceled. For example, if the integrated management system 301 is ended while the temporary library is displayed, the temporary library is preferably displayed when the integrated management system 301 is restarted. If the integrated management system 301 is ended while the file in the temporary library is edited, it is preferable not to cancel the registration of the temporary library when the user designates a storage destination of the file to the temporary library. Therefore, the data processing apparatus according to the third exemplary embodiment excludes the temporary library from a canceling target of the registration if a predetermined condition is satisfied.

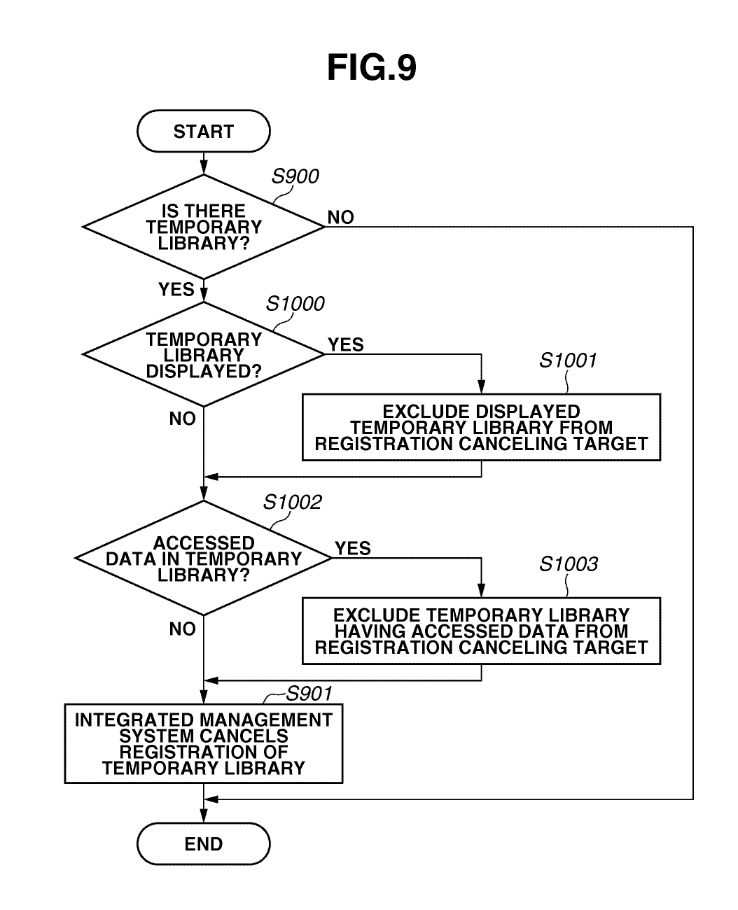

FIG. 9 illustrates a flowchart of the registration canceling processing of the temporary library according to the third exemplary embodiment. In step S900, the integrated management unit 303 determines whether there is the registered temporary library at the end of the operation of the integrated management system 301. If the integrated management unit 303 determines that there is no registered temporary library (NO in step S900), the processing ends. If the integrated management unit 303 determines that there is the registered temporary library (YES in step S900), the processing proceeds to step S1000.

In step S1000, the integrated management unit 303 determines whether the temporary library is displayed. If the integrated management unit 303 determines that the temporary library is displayed (YES in step S1000), then in step S1001, the integrated management unit 303 excludes the displayed temporary library from the registration canceling target, and the processing proceeds to step S1002. If the integrated management unit 303 determines that the temporary library is not displayed (NO in step S1000), the processing proceeds to step S1002.

In step S1002, the integrated management unit 303 determines whether the temporary library includes data which is being accessed. More specifically, the integrated management unit 303 checks the currently opened file in the data files in the temporary library.

For example, the integrated management unit 303 checks the file when opening the file in the temporary library, and cancels the check after closing the file. Thus, if there is the file checked in the determination processing in step S1002, the integrated management unit 303 determines that the temporary library includes the data which is being accessed (YES in step S1002). If there is no file checked in the determination processing in step S1002, the integrated management unit 303 determines that the temporary library does not include the data which is being accessed (NO in step S1002).

If the integrated management unit 303 determines that the temporary library includes the data which is being accessed (YES in step S1002), then in step S1003, the integrated management unit 303 excludes the temporary library including the data which is being accessed from the registration canceling target. Then, the processing proceeds to step S901. If the integrated management unit 303 determines that the temporary library does not include the data which is being accessed (NO in step S1002), the processing proceeds to step S901. In step S901, the integrated management unit 303 cancels the registration of the temporary library.

According to the third exemplary embodiment, the registration is not canceled when the temporary library is displayed or when the temporary library includes the data which is being accessed. In another case, the registration may not be canceled. For example, if the number of the temporary libraries or the number of accesses to the file in the temporary library is larger than a threshold, the integrated management unit 303 may not cancel the registration.

According to the third exemplary embodiment, the data processing apparatus automatically selects the library whose registration may not be canceled from the libraries registered in the processing in step S706 in FIG. 6, and excludes the selected library from the registration canceling target. Consequently, the integrated management system 301 is ended while the temporary library is displayed. If the integrated management system 301 is restarted, the temporary library remains on the display. Thus, the user can easily access the temporary library.

With the integrated management apparatus according to the present invention, if the folder on the reference destination of the shortcut file is registered to the library to be referred to from the integrated management apparatus 301, the integrated management system 301 displays the folder without starting the document management system that manages the folder on the reference destination. Therefore, a user can save time and effort for operating a plurality of the document management systems, and further the cooperation between the document management systems becomes easy.

Aspects of the present invention can also be realized by a computer of a system or apparatus (or devices such as a CPU or an MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-165115 filed Jul. 28, 2011, which is hereby incorporated by reference herein in its entirety.

What is claimed is:

1. An integrated management apparatus that manages a folder managed by a plurality of document management systems, the integrated management apparatus comprising:
a registration unit configured to register a library associated with a reference destination of a shortcut file;
a first determination unit configured to determine whether a selected file is the shortcut file;
a second determination unit configured to determine whether the reference destination of the shortcut file is a folder if it is determined that the selected file is the shortcut file;
a third determination unit configured to determine whether the folder can be referred to via the library if it is determined that the reference destination of the shortcut file is the folder; and
a first display unit configured to display information indicating the folder without starting the document management system that manages the folder if it is determined that the folder can be referred to via the library.

2. The integrated management apparatus according to claim 1, wherein, if the third determination unit determines that a folder on the reference destination of the shortcut file cannot be referred to via the library, the registration unit determines whether the folder can be referred to from the integrated management apparatus, and if it is determined that the folder can be referred to from the integrated management apparatus, the registration unit registers a library associated with the folder.

3. The integrated management apparatus according to claim 2, further comprising a registration canceling unit configured to determine whether there is the library registered by the registration unit at an end of an operation of the integrated management apparatus, and perform processing for canceling the registration of the library if it is determined that there is the library.

4. The integrated management apparatus according to claim 3, further comprising:
a second display unit configured to display the registered library,
wherein, if it is determined that there is the registered library, the registration canceling unit determines whether the library is in a state being displayed by the second display unit, and excludes the library from a target of the registration canceling processing if it is determined that the library is in the state being displayed by the second display unit.

5. The integrated management apparatus according to claim 4, wherein, if it is determined that the library is not in the state being displayed by the second display unit, the registration canceling unit determines whether the library includes data which is being accessed, and excludes the library from the target of the registration canceling processing if it is determined that the library includes the data which is being accessed.

6. A method for managing a document executed by an integrated management apparatus that manages a folder managed by a plurality of document management systems, the method comprising:
registering a library associated with a reference destination of a shortcut file;
determining whether a selected file is the shortcut file;
determining whether the reference destination of the shortcut file is a folder if it is determined that the selected file is the shortcut file;
determining whether the folder can be referred to via the library if it is determined that the reference destination of the shortcut file is the folder; and
displaying information indicating the folder without starting the document management system that manages the folder if it is determined that the folder can be referred to via the library.

7. The method according to claim 6, further comprising:
determining whether the folder can be referred to from the integrated management apparatus if it is determined that the folder on the reference destination of the shortcut file cannot be referred to via the library, and
registering a library associated with the folder if it is determined that the folder can be referred to from the integrated management apparatus.

8. The method according to claim 7, further comprising determining whether there is the registered library at an end of an operation of the integrated management apparatus, and performing processing for canceling the registration of the library if it is determined that there is the library.

9. The method according to claim 8, further comprising:
displaying the registered library; and
determining whether the library is in a state being displayed and excluding the library from a target of the registration canceling processing if it is determined that the library is in the state being displayed.

10. The method according to claim 9, further comprising determining whether the library includes data which is being accessed if it is determined that the library is not in the state being displayed and excluding the library from the target of the registration canceling processing if it is determined that the library includes the data which is being accessed.

11. A non-transitory computer readable storage medium that stores a program for causing a computer that manages a folder managed by a plurality of document management systems to function as:
a registration unit configured to register a library associated with a reference destination of a shortcut file;
a first determination unit configured to determine whether a selected file is the shortcut file;
a second determination unit configured to determine whether the reference destination of the shortcut file is a folder if it is determined that the selected file is the shortcut file;
a third determination unit configured to determine whether the folder can be referred to via the library if it is determined that the reference destination of the shortcut file is the folder; and
a first display unit configured to display information indicating the folder without starting the document management system that manages the folder if it is determined that the folder can be referred to via the library.

12. The non-transitory computer readable storage medium according to claim 11, wherein, if the third determination unit determines that a folder on the reference destination of the shortcut file cannot be referred to via the library, the registration unit determines whether the folder can be referred to from the computer, and
if it is determined that the folder can be referred to from the computer, the registration unit registers a library associated with the folder.

13. The non-transitory computer readable storage medium according to claim 12, wherein the program further causing the computer to function as: a registration canceling unit configured to determine whether there is the library registered by the registration unit at an end of an operation of the computer, and perform processing for canceling the registration of the library if it is determined that there is the library.

14. The non-transitory computer readable storage medium according to claim 13, wherein the program further causing the computer to function as:
a second display unit configured to display the registered library,
wherein, if it is determined that there is the registered library, the registration canceling unit determines whether the library is in a state being displayed by the second display unit, and excludes the library from a target of the registration canceling processing if it is determined that the library is in the state being displayed by the second display unit.

15. The non-transitory computer readable storage medium according to claim 14, wherein, if it is determined that the library is not in the state being displayed by the second display unit, the registration canceling unit determines whether the library includes data which is being accessed, and excludes the library from the target of the registration canceling processing if it is determined that the library includes the data which is being accessed.
